(19) United States
(12) Patent Application Publication
(10) Pub. No.: US 2019/0300752 A1
(43) Pub. Date: Oct. 3, 2019

(54) ADHESIVE AND METHOD FOR PREPARING THE SAME

(71) Applicant: MEGAFORCE COMPANY LIMITED, New Taipei City (TW)

(72) Inventors: Guo-Tao ZHOU, New Taipei City (TW); Wei-Chin CHEN, New Taipei City (TW)

(21) Appl. No.: 16/134,432

(22) Filed: Sep. 18, 2018

(30) Foreign Application Priority Data
Apr. 3, 2018 (CN) 201810303795.1

(51) Int. Cl. C09J 4/06; C09J 4/00

(52) U.S. Cl. CPC C09J 4/06; C09J 4/00

(57) ABSTRACT

An adhesive and a method for preparing the adhesive are provided. The adhesive includes 20 parts by weight to 80 parts by weight of a prepolymer, 0.01 parts by weight to 30 parts by weight of a dopamine derivative, and 0.1 parts by weight to 10 parts by weight of an initiator. The adhesive has advantages such as fast curing, high heat resistance, and strong adhesion.

### CROSS-REFERENCE TO RELATED APPLICATION

This non-provisional application claims priority under 35 U.S.C. § 119(a) to Patent Application No. 201810303795.1 filed in China, P.R.C. on Apr. 3, 2018, the entire contents of which are hereby incorporated by reference.

### BACKGROUND

### Technical Field

The instant disclosure generally relates to an adhesive and, more particularly, to an adhesive including dopamine derivative(s).

### Related Art

Adhesives have advantages such as fast curing, high strength, and environmental-friendly. Therefore, they are widely used in the fields of optics, electronics, medical and health, aviation, printing, and so on.

However, different types of solid adhesives have certain limitations. For example, adhesives mainly composed of polyurethane acrylate, acrylate, or the like exhibit poor heat resistance and may be easily softened at high temperatures; and adhesives mainly composed of bisphenol A or cycloaliphatic epoxy resins exhibit slow curing and weak adhesion.

Therefore, there is a need to provide an adhesive with fast curing, strong adhesion, and high heat resistance to enhance its utility value and applications.

### SUMMARY

One embodiment of the instant disclosure provides an adhesive including 20 parts by weight to 80 parts by weight of a prepolymer, 0.01 parts by weight to 30 parts by weight of a dopamine derivative, and 0.1 parts by weight to 10 parts by weight of an initiator.

In one embodiment, the adhesive further includes 20 parts by weight to 80 parts by weight of a reactive diluent.

In one embodiment, the adhesive includes 30 parts by weight to 70 parts by weight of the prepolymer, 0.1 parts by weight to 30 parts by weight of the dopamine derivative, and 3 parts by weight to 8 parts by weight of the initiator.

In one embodiment, the initiator is a photoinitiator, a thermal initiator, or a combination of the foregoing.

In one embodiment, the prepolymer is a pure acrylate resin, a bisphenol A epoxy acrylate resin, a novolac epoxy acrylate resin, an epoxidized oil acrylate resin, a modified epoxy acrylate resin, an aliphatic polyurethane acrylate resin, an aromatic polyurethane acrylate resin, a polyester acrylate resin, a hyperbranched polyfunctional polyester resin, a bisphenol A epoxy resin, a cycloaliphatic epoxy resin or a combination of the foregoing.

Another embodiment of the instant disclosure provides a method for preparing an adhesive. The method includes: mixing and stirring 0.01 parts by weight to 10 parts by weight of ethanol and 0.01 parts by weight to 30 parts by weight of a dopamine derivative at a stirring speed within a range from 50 revolutions per minute (rpm) to 800 revolutions per minute (rpm) at a temperature within a range from 20° C. to 30° C. for a stirring time within a range from 10 minutes to 30 minutes to obtain a dopamine solution; mixing and stirring 0.1 parts by weight to 20 parts by weight of an initiator and 0.01 parts by weight to 5 parts by weight of a reactive diluent at a stirring speed within a range from 50 revolutions per minute (rpm) to 800 revolutions per minute (rpm) at a temperature within a range from 10° C. to 30° C. for a stirring time within a range from 20 minutes to 60 minutes to obtain an initiator solution; mixing and stirring the dopamine solution, the initiator solution, and 20 parts by weight to 100 parts by weight of a prepolymer at a stirring speed within a range from 100 revolutions per minute (rpm) to 500 revolutions per minute (rpm) at a temperature within a range from 20° C. to 30° C. for a stirring time within a range from 60 minutes to 120 minutes to obtain a preliminary adhesive; and stirring and defoaming the preliminary adhesive at a stirring speed within a range from 5 revolutions per minute (rpm) to 50 revolutions per minute (rpm) at a vacuum degree of 0.1 Mpa for 3 hours (Hr) to 8 hours (Hr).

A further another embodiment of the instant disclosure further provides a method for preparing an adhesive. The method includes: mixing and stirring 0.01 parts by weight to 10 parts by weight of ethanol and 0.01 parts by weight to 30 parts by weight of a dopamine derivative at a stirring speed within a range from 50 revolutions per minute (rpm) to 800 revolutions per minute (rpm) at a temperature within a range from 20° C. to 30° C. for a stirring time within a range from 10 minutes to 30 minutes to obtain a dopamine solution; mixing and stirring 0.1 parts by weight to 20 parts by weight of an initiator and 0.01 parts by weight to 5 parts by weight of a first reactive diluent at a stirring speed within a range from 50 revolutions per minute (rpm) to 800 revolutions per minute (rpm) at a temperature within a range from 10° C. to 30° C. for a stirring time within a range from 20 minutes to 60 minutes to obtain an initiator solution; mixing and stirring the dopamine solution, the initiator solution, and 20 parts by weight to 80 parts by weight of a second reactive diluent at a stirring speed within a range from 50 revolutions per minute (rpm) to 800 revolutions per minute (rpm) at a temperature within a range from 20° C. to 30° C. for a stirring time within a range from 20 minutes to 60 minutes to obtain a reaction solution; mixing and stirring the reaction solution and 20 parts by weight to 100 parts by weight of a prepolymer at a stirring speed within a range from 100 revolutions per minute (rpm) to 500 revolutions per minute (rpm) at a temperature within a range from 20° C. to 30° C. for a stirring time within a range from 60 minutes to 120 minutes to obtain a preliminary adhesive; and stirring and defoaming the preliminary adhesive at a stirring speed within a range from 5 revolutions per minute (rpm) to 50 revolutions per minute (rpm) at a vacuum degree of 0.1 Mpa for 3 hours (Hr) to 8 hours (Hr).

A yet another embodiment of the instant disclosure further provides a method for preparing an adhesive. The method includes: mixing and stirring 0.01 parts by weight to 30 parts by weight of a dopamine derivative, 0.1 parts by weight to 20 parts by weight of an initiator, and 1 part by weight to 3 parts by weight of phenyl glycidyl ether at a stirring speed within a range from 50 revolutions per minute (rpm) to 800 revolutions per minute (rpm) at a temperature within a range from 10° C. to 30° C. for a stirring time within a range from 20 minutes to 60 minutes to obtain a reaction solution; mixing and stirring the reaction solution and 0.01 parts by weight to 5 parts by weight of a reactive diluent at a stirring speed within a range from 50 revolutions per minute (rpm) to 800 revolutions per minute (rpm) at a temperature within a range from 10° C. to 30° C. for a stirring time within a range from 20 minutes to 60 minutes to obtain a mixture solution; mixing and stirring the mixture solution and 20 parts by weight to 100 parts by weight of a prepolymer at a stirring speed within a range from 100 revolutions per minute (rpm) to 500 revolutions per minute (rpm) at a temperature within a range from 20° C. to 30° C. for a stirring time within a range from 60 minutes to 120 minutes to obtain a preliminary adhesive; and stirring and defoaming the preliminary adhesive at a stirring speed within a range from 5 revolutions per minute (rpm) to 50 revolutions per minute (rpm) at a vacuum degree of 0.1 Mpa for 3 hours (Hr) to 8 hours (Hr) to obtain the adhesive.

In one embodiment, the prepolymer is a pure acrylate resin, a bisphenol A epoxy acrylate resin, a novolac epoxy acrylate resin, an epoxidized oil acrylate resin, a modified epoxy acrylate resin, an aliphatic polyurethane acrylate resin, an aromatic polyurethane acrylate resin, a polyester acrylate resin, a hyperbranched polyfunctional polyester resin, a bisphenol A epoxy resin, a cycloaliphatic epoxy resin or a combination of the foregoing.

In one embodiment, the initiator is a photoinitiator, a thermal initiator, or a combination of the foregoing.

A still another embodiment of the instant disclosure further provides an adhesive according to Formula (1):

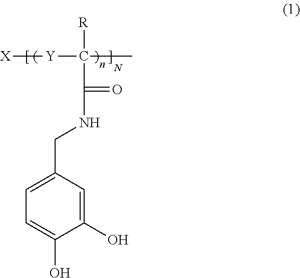

wherein X represents a crosslinked or partially crosslinked prepolymer, R represents hydrogen, hydroxyl, alkyl or alkoxy, Y represents alkyl, cycloalkyl, aryl or aralkyl, and each of n and N is an integer larger than 1.

According to the above-mentioned embodiments, the adhesive is a single component in the system and can be cured by light or heat. The light-irradiatable part of the adhesive can be quickly cured. When a certain part of the adhesive is hard to be irradiated and cured, it can be heated for the curing. The adhesive according to the above-mentioned embodiments exhibits fast curing, high heat resistance, and strong adhesion, and can be widely used in various applications.

### BRIEF DESCRIPTION OF THE DRAWINGS

This disclosure will become more fully understood from the detailed description given herein below for illustration only, and thus not limitative of this disclosure, wherein:

FIG. 1 is a flowchart of a method for preparing an adhesive according to one embodiment of the instant disclosure;

FIG. 2 is a flowchart of a method for preparing an adhesive according to another embodiment of the instant disclosure; and

FIG. 3 is a flowchart of a method for preparing an adhesive according to still another embodiment of the instant disclosure.

### DETAILED DESCRIPTION

In one embodiment of the instant disclosure, an adhesive includes 20 parts by weight to 80 parts by weight of a prepolymer, 0.01 parts by weight to 30 parts by weight of a dopamine derivative, and 0.1 parts by weight to 10 parts by weight of an initiator. In one embodiment, the prepolymer may be a pure acrylate resin, a bisphenol A epoxy acrylate resin, a novolac epoxy acrylate resin, an epoxidized oil acrylate resin, a modified epoxy acrylate resin, an aliphatic polyurethane acrylate resin, an aromatic polyurethane acrylate resin, a polyester acrylate resin, a hyperbranched polyfunctional polyester resin, a bisphenol A epoxy resin, a cycloaliphatic epoxy resin, or a combination of the foregoing.

In one embodiment, the dopamine derivative is a monomer or a polymer having a dopamine catechol structure, as represented by Formula (A) below, wherein R is a group that contains both a carbon-carbon double bond and a carbon-oxygen double bond.

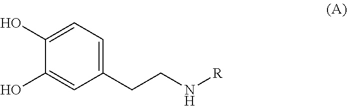

In one embodiment, the dopamine derivative may be represented by Formula (B) below:

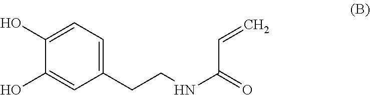

In another embodiment, the dopamine derivative may be represented by Formula (C) below:

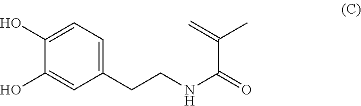 [SMILES: C=C(C)C(=O)NCCc1ccc(O)c(O)c1]

In one embodiment, the initiator is a photoinitiator, a thermal initiator, or a combination of the foregoing. In some embodiments, the photoinitiator is further classified as the radical initiator and the cationic initiator. The radical photoinitiator may be 2-hydroxy-2-methylpropiophenone (photoinitiator 1173), diphenyl(2,4,6-trimethylbenzoyl)phosphine oxide (TPO), 2-hydroxy-4′-(2-hydroxyethoxy)-2-methyl-propiophe (photoinitiator 2959), Phenylbis(2,4,6-trimethylbenzoyl)phosphine oxide (photoinitiator 819), 1-hydroxycyclohexyl phenyl ketone (photoinitiator 184), or a combination of the foregoing. The cationic photoinitiator may be diphenyliodonium hexafluorophosphate, diphenylsulfonium hexafluorophosphate, triarylsulfonium hexafluoroantimonate, triarylsulfonium hexafluorophosphate, triarylsulfonium borate, mixed sulfonium hexafluoroantimonate, mixed sulfonium hexafluorophosphate, or a combination of the foregoing. In some embodiments, the thermal initiator is classified as the peroxide initiator and the cationic acid thermal initiator. The peroxide initiator is cumene hydroperoxide (CHP), dicumyl peroxide (DCP), dilauroyl peroxide (LPO), dibenzoyl peroxide (BPO), or azobisisobutyronitrile. The cationic thermal initiator is sulfonium hexafluorophosphate or sulfonium borate.

In one embodiment, the adhesive further includes 20 parts by weight to 80 parts by weight of a reactive diluent. In one embodiment, the reactive diluent may be monofunctional, difunctional or polyfunctional acrylate. In another embodiment, the reactive diluent may be a monofunctional or difunctional epoxy resin. In still another embodiment, the reactive diluent may be an alcohol solvent, an ester solvent or a combination of the foregoing. Detailed descriptions thereof will be further presented herein.

In some embodiments, the monofunctional acrylate in the reactive diluent may be lauryl acrylate, lauryl methacrylate, isobornyl acrylate, isobornyl methacrylate, tetrahydrofuran acrylate, 2-(2-ethoxyethoxy) ethyl acrylate, or a combination of the foregoing. The difunctional acrylate may be diethylene glycol diacrylate, triethylene glycol diacrylate, dipropylene glycol diacrylate, tripropylene glycol diacrylate, 1,4-butanediol diacrylate, 1,6-hexamethylene diacrylate, neopentyl glycol diacrylate, phthalate diethylene glycol diacrylate, polyethylene glycol (200) diacrylate, polyethylene glycol (400) diacrylate, polyethylene glycol (600) diacrylate, or a combination of the foregoing. The polyfunctional acrylate may be trimethylolpropane triacrylate, pentaerythritol triacrylate, trimethylolpropane triacrylate, dipentaerythritol pentaacrylate, tris(2-hydroxy ethyl) isocyanurate triacrylate, ethoxylated (15) trimethylolpropane triacrylate, di-trimethylolpropane tetraacrylate, or a combination of the foregoing.

In some other embodiments, the monofunctional epoxy resin in the reactive diluent may be 3-ethyl-3-oxetanemethanol (CAS No.: 3047-32-3), 3-ethyl-3 [[(3-ethyloxetane-3-yl)methoxy]methyl]oxetane (CAS No.:18934-00-4), phenyl glycidyl ether, or a combination of the foregoing. The difunctional epoxy resin may be 1,2-epoxy-4-vinylcyclohexane, 3,4-epoxycyclohexylmethyl methacrylate, or a combination of the foregoing.

In some other embodiments, the alcohol solvent and the ester solvent in the reactive diluent may be ethanol, glycerol, γ-butyrolactone, or a combination of the foregoing.

With respect to the properties of the adhesive, in one embodiment, the viscosity of the adhesive is within a range from 500 mPas·s⁻¹ to 10000 mPas·s⁻¹ at 25° C. At 25° C., the shearing force of the adhesive is within a range from 4 Mpa to 7 Mpa when the adhesive is bonded to a glass material. The glass transition temperature (Tg) of the adhesive is within a range from 65° C. to 150° C.

In one embodiment, the adhesive includes 30 parts by weight to 70 parts by weight of the prepolymer, 0.1 parts by weight to 30 parts by weight of the dopamine derivative, and 3 parts by weight to 8 parts by weight of the initiator.

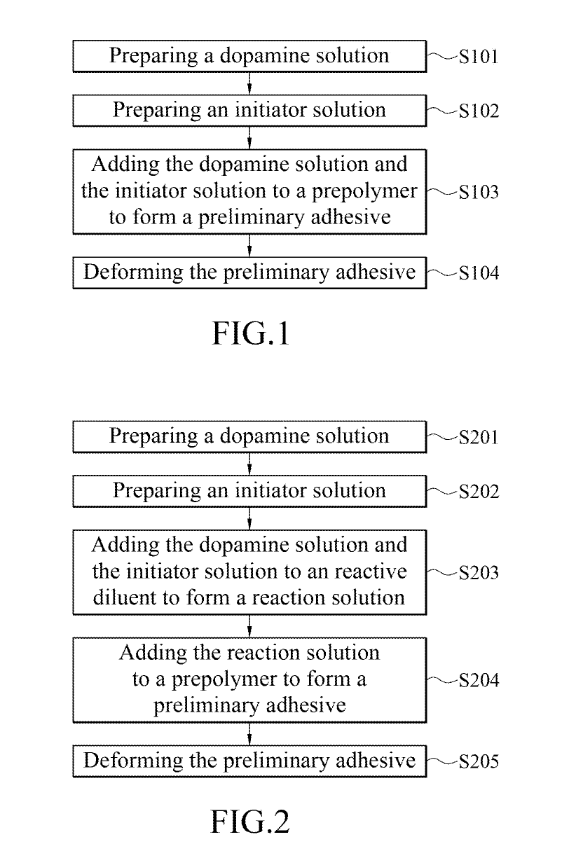

FIG. 1 is a flowchart of a method for preparing an adhesive according to one embodiment of the instant disclosure. Referring to FIG. 1, the method for preparing an adhesive includes the steps of preparing a dopamine solution (Step S101), preparing an initiator solution (Step S102), adding the dopamine solution prepared in Step S101 and the initiator solution prepared in Step S102 to a prepolymer to form a preliminary adhesive (Step S103) and defoaming the preliminary adhesive (Step S104). Detailed descriptions of the steps are given herein:

In Step S101, at a temperature within a range from 20° C. to 30° C., 0.01 parts by weight to 10 parts by weight of ethanol and 0.01 parts by weight to 30 parts by weight of a dopamine derivative are mixed and stirred at a stirring speed within a range from 50 revolutions per minute (rpm) to 800 revolutions per minute (rpm) for a stirring time within a range from 10 minutes to 30 minutes to obtain a dopamine solution.

In Step S102, at a temperature within a range from 10° C. to 30° C., 0.1 parts by weight to 20 parts by weight of an initiator and 0.01 parts by weight to 5 parts by weight of a reactive diluent are mixed and stirred at a stirring speed within a range from 50 revolutions per minute (rpm) to 800 revolutions per minute (rpm) for a stirring time within a range from 20 minutes to 60 minutes to obtain an initiator solution.

In Step S103, at a temperature within a range from 20° C. to 30° C., the dopamine solution, the initiator solution, and 20 parts by weight to 100 parts by weight of a prepolymer are mixed and stirred at a stirring speed within a range from 100 revolutions per minute (rpm) to 500 revolutions per minute (rpm) for a stirring time within a range from 60 minutes to 120 minutes to obtain a preliminary adhesive. In one embodiment, the prepolymer may be a pure acrylate resin, a bisphenol A epoxy acrylate resin, a novolac epoxy acrylate resin, an epoxidized oil acrylate resin, a modified epoxy acrylate resin, an aliphatic urethane acrylate resin, an aromatic polyurethane acrylate resin, a polyester acrylate resin, a hyperbranched polyfunctional polyester resin, a bisphenol A epoxy resin, a cycloaliphatic epoxy resin or a combination of the foregoing.

In Step S104, the preliminary adhesive is stirred and defoamed at a stirring speed within a range from 5 revolutions per minute (rpm) to 50 revolutions per minute (rpm) at a vacuum degree of 0.1 Mpa for 3 hours (Hr) to 8 hours (Hr) to obtain an adhesive.

FIG. 2 is a flowchart of a method for preparing an adhesive according to another embodiment of the instant disclosure. Referring to FIG. 2, the method for preparing an adhesive includes the steps of preparing a dopamine solution (Step S201), preparing an initiator solution (Step S202), adding the dopamine solution prepared in Step S201 and the initiator solution prepared in Step S202 to a reactive diluent to form a reaction solution (Step S203), adding the reaction solution to a prepolymer to form a preliminary adhesive (Step S204), and defoaming the preliminary adhesive (Step S205). Detailed descriptions of the steps are given herein:

In Step S201, 0.01 parts by weight to 10 parts by weight of ethanol and 0.01 parts by weight to 30 parts by weight of a dopamine derivative are mixed and stirred at a temperature within a range from 20° C. to 30° C. at a stirring speed within a range from 50 revolutions per minute (rpm) to 800 revolutions per minute (rpm) for a stirring time within a range from 10 minutes to 30 minutes to obtain a dopamine solution.

In Step S202, 0.1 parts by weight to 20 parts by weight of an initiator and 0.01 parts by weight to 5 parts by weight of a first reactive diluent are mixed and stirred at a temperature within a range from 10° C. to 30° C. at a stirring speed within a range from 50 revolutions per minute (rpm) to 800 revolutions per minute (rpm) for a stirring time within a range from 20 minutes to 60 minutes to obtain an initiator solution.

In Step S203, the dopamine solution, the initiator solution, and 20 parts by weight to 80 parts by weight of a second reactive diluent are mixed and stirred at a stirring speed within a range from 50 revolutions per minute (rpm) to 800 revolutions per minute (rpm) at a temperature within a range from 20° C. to 30° C. for a stirring time within a range from 20 minutes to 60 minutes to obtain a reaction solution.

It should be noted that, in one embodiment, the first reactive diluent and the second reactive diluent may be monofunctional, difunctional or polyfunctional acrylate, respectively. In another embodiment, the first reactive diluent and the second reactive diluent may be monofunctional or difunctional epoxy resin, respectively. In still another embodiment, the first reactive diluent and the second reactive diluent may be an alcohol solvent, an ester solvent, or a combination of the foregoing, respectively.

In another embodiment, the first reactive diluent and the second reactive diluent may be different reactive diluents. For example, the first reactive diluent is phenyl glycidyl ether, while the second reactive diluent is an epoxy resin oligomer. However, the first reactive diluent and the second reactive diluent may be the same reactive diluent, to which the instant disclosure is not limited.

In Step S204, the reaction solution and 20 parts by weight to 100 parts by weight of a prepolymer are mixed and stirred at a stirring speed within a range from 100 revolutions per minute (rpm) to 500 revolutions per minute (rpm) at a temperature within a range from 20° C. to 30° C. for a stirring time within a range from 60 minutes to 120 minutes to obtain a preliminary adhesive.

In Step S205, the preliminary adhesive is stirred and defoamed at a stirring speed within a range from 5 revolutions per minute (rpm) to 50 revolutions per minute (rpm) at a vacuum degree of 0.1 Mpa for 3 hours (Hr) to 8 hours (Hr) to obtain an adhesive.

For example, first, 2 parts by weight of ethanol and 0.2 parts by weight of a dopamine derivative are stirred and mixed at a temperature of 26° C. at a stirring speed of 100 revolutions per minute (rpm) for a stirring time of 10 minutes to obtain a dopamine solution.

Next, 1 part by weight of phenyl glycidyl ether, 3.5 parts by weight of a photoinitiator, and 1.3 parts by weight of a thermal initiator are mixed at a temperature of 26° C. and stirred at a stirring speed of 400 revolutions per minute (rpm) for a stirring time of 230 minutes to obtain an initiator solution.

Next, a dopamine solution, an initiator solution, and 22.25 parts by weight of 3,4-epoxycyclohexylmethyl acrylate are mixed in order at a temperature of 26° C. and stirred at a stirring speed of 500 revolutions per minute (rpm) for a stirring time of 30 minutes to obtain a reaction solution.

Next, the reaction solution and 70 parts by weight of cycloaliphatic epoxy resin are mixed at a temperature of 26° C. and stirred at a stirring speed of 500 revolutions per minute (rpm) for a stirring time of 90 minutes to obtain a preliminary adhesive.

Then, the preliminary adhesive is stirred at a stirring speed of 30 revolutions per minute (rpm) and deformed at a vacuum degree of 0.1 Mpa for 8 hours (Hr) to obtain an adhesive.

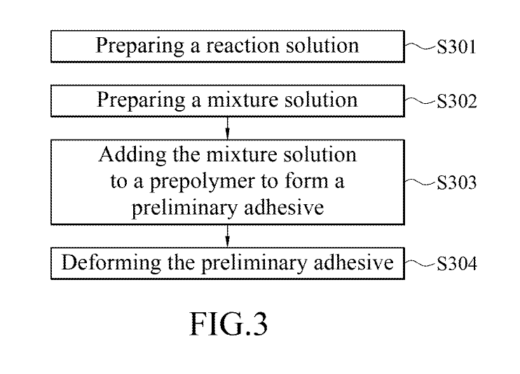

FIG. 3 is a flowchart of a method for preparing an adhesive according to still another embodiment of the instant disclosure. Referring to FIG. 3, the method for preparing an adhesive includes the steps of preparing a reaction solution (Step S301), preparing a mixture solution by adding the reaction solution prepared in Step S301 to a reactive diluent (Step S302), adding the mixture solution to a prepolymer to form a preliminary adhesive (Step S303) and defoaming the preliminary adhesive (Step S304). Detailed descriptions of the steps are given herein:

In Step S301, 0.01 parts by weight to 30 parts by weight of a dopamine derivative, 0.1 parts by weight to 20 parts by weight of an initiator, and 1 part by weight to 3 parts by weight of phenyl glycidyl ether are mixed and stirred at a temperature within a range from 10° C. to 30° C. at a stirring speed within a range from 50 revolutions per minute (rpm) to 800 revolutions per minute (rpm) for a stirring time within a range from 20 minutes to 60 minutes to obtain a reaction solution. In one embodiment, 0.2 parts by weight of a dopamine derivative, 1 part by weight of phenyl glycidyl ether, 3.5 parts by weight of triarylsulfonium hexafluoroantimonate (as an initiator), and 1.3 parts by weight of diphenylsulfonium hexafluorophosphate (as an initiator) are mixed and stirred at a temperature of 26° C. at a stirring speed of 400 revolutions per minute (rpm) for a stirring time of 30 minutes to obtain a reaction solution. Here, the reaction solution prepared in Step S301 is different from the reaction solution prepared in Step S203. In Step S301, phenyl glycidyl ether is a monofunctional epoxy monomer and is capable of participating in the reaction. In Step S302, the reaction solution and 0.01 parts by weight to 5 parts by weight of a reactive diluent are mixed and stirred at a temperature within a range from 10° C. to 30° C. at a stirring speed within a range from 50 revolutions per minute (rpm) to 800 revolutions per minute (rpm) for a stirring time within a range from 20 minutes to 60 minutes to obtain a mixture solution.

In Step S303, the mixture solution and 20 parts by weight to 100 parts by weight of a prepolymer are mixed and stirred at a temperature within a range from 20° C. to 30° C. at a stirring speed within a range from 100 revolutions per minute (rpm) to 500 revolutions per minute (rpm) for a stirring time within a range from 60 minutes to 120 minutes to obtain a preliminary adhesive.

In Step S304, the preliminary adhesive is stirred at a stirring speed within a range from 5 revolutions per minute (rpm) to 50 revolutions per minute (rpm) and defoamed at a vacuum degree of 0.1 Mpa for 3 hours (Hr) to 8 hours (Hr) to obtain an adhesive.

In one embodiment, when the prepolymer is an epoxy resin, the dopamine derivative winds around the epoxy resin that forms the crosslinked structure or forms an interpenetrating polymer network (IPN) with the epoxy resin after the epoxy resin reacts with the dopamine derivative. In another embodiment, when the prepolymer is acrylate, for example, but not limited to, epoxy acrylate, polyurethane acrylate resin and other resins containing reactive double bond(s), part of the dopamine derivative winds around the main chain and another part of the dopamine derivative is connected to the main chain after the acrylate reacts with the dopamine derivative. Here, physical crosslinking and chemical crosslinking may occur when the adhesive is irradiated with light (for example, the ultraviolet light) or receives heat. In one embodiment, the adhesive may be represented by Formula (1) below:

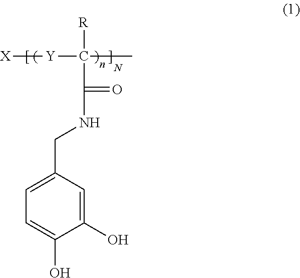

In Formula (1), X represents a crosslinked or partially crosslinked prepolymer and X has a three-dimensional network structure, R represents hydrogen, hydroxyl, alkyl, or alkoxy, Y represents alkyl, cycloalkyl, aryl, or aralkyl, and each of n and N is an integer larger than 1. Here, X may be connected to one long chain or one short chain, or X may be connected to N long chains or N short chains.

In one of the above-mentioned embodiments, the adhesive includes a dopamine derivative, which is a secretion from mussels in the ocean and exhibits adhesion. The dopamine derivative contains a small-molecule catechol group or a small-molecule polymer. The dopamine derivative is added to a prepolymer, along with a thermal initiator or a photoinitiator, to facilitate the prepolymer to be crosslinked by light or heat. During the crosslinking reaction, the catechol group (C₆H₄(OH)₂) is reacted on the polymer chain. Since catechol exhibits a strong binding force and high reduction ability, the resulting adhesive exhibits excellent adhesion. Additionally, in another embodiment, the adhesive exhibits fast curing, strong adhesion, and high heat resistance to enhance its utility value and applications.

What is claimed is:

1. An adhesive, comprising:
20 parts by weight to 80 parts by weight of a prepolymer;
0.01 parts by weight to 30 parts by weight of a dopamine derivative; and
0.1 parts by weight to 10 parts by weight of an initiator.

2. The adhesive according to claim 1, further comprising 20 parts by weight to 80 parts by weight of a reactive diluent.

3. The adhesive according to claim 1, wherein said adhesive comprises 30 parts by weight to 70 parts by weight of said prepolymer, 0.1 parts by weight to 30 parts by weight of said dopamine derivative, and 3 parts by weight to 8 parts by weight of said initiator.

4. The adhesive according to claim 1, wherein said initiator is a photoinitiator, a thermal initiator or a combination of the foregoing.

5. The adhesive according to claim 1, wherein said prepolymer is a pure acrylate resin, a bisphenol A epoxy acrylate resin, a novolac epoxy acrylate resin, an epoxidized oil acrylate resin, a modified epoxy acrylate resin, an aliphatic urethane acrylate resin, an aromatic polyurethane acrylate resin, a polyester acrylate resin, a hyperbranched polyfunctional polyester resin, a bisphenol A epoxy resin, a cycloaliphatic epoxy resin or a combination of the foregoing.

6. A method for preparing an adhesive, comprising:
mixing and stirring 0.01 parts by weight to 10 parts by weight of ethanol and 0.01 parts by weight to 30 parts by weight of a dopamine derivative at a stirring speed within a range from 50 revolutions per minute (rpm) to 800 revolutions per minute (rpm) at a temperature within a range from 20° C. to 30° C. for a stirring time within a range from 10 minutes to 30 minutes to obtain a dopamine solution;
mixing and stirring 0.1 parts by weight to 20 parts by weight of an initiator and 0.01 parts by weight to 5 parts by weight of a reactive diluent at a stirring speed within a range from 50 revolutions per minute (rpm) to 800 revolutions per minute (rpm) at a temperature within a range from 10° C. to 30° C. for a stirring time within a range from 20 minutes to 60 minutes to obtain an initiator solution;
mixing and stirring said dopamine solution, said initiator solution, and 20 parts by weight to 100 parts by weight of a prepolymer at a stirring speed within a range from 100 revolutions per minute (rpm) to 500 revolutions per minute (rpm) at a temperature within a range from 20° C. to 30° C. for a stirring time within a range from 60 minutes to 120 minutes to obtain a preliminary adhesive; and
stirring and defoaming said preliminary adhesive at a stirring speed within a range from 5 revolutions per minute (rpm) to 50 revolutions per minute (rpm) at a vacuum degree of 0.1 Mpa for 3 hours (Hr) to 8 hours (Hr) to obtain said adhesive.

7. The method according to claim 6, wherein said initiator is a photoinitiator, a thermal initiator, or a combination of the foregoing.

8. The method according to claim 6, wherein said prepolymer is a pure acrylate resin, a bisphenol A epoxy acrylate resin, a novolac epoxy acrylate resin, an epoxidized oil acrylate resin, a modified epoxy acrylate resin, an aliphatic urethane acrylate resin, an aromatic polyurethane acrylate resin, a polyester acrylate resin, a hyperbranched polyfunctional polyester resin, a bisphenol A epoxy resin, a cycloaliphatic epoxy resin, or a combination of the foregoing.

9. A method for preparing an adhesive, comprising:
mixing and stirring 0.01 parts by weight to 10 parts by weight of ethanol and 0.01 parts by weight to 30 parts by weight of a dopamine derivative at a stirring speed within a range from 50 revolutions per minute (rpm) to 800 revolutions per minute (rpm) at a temperature within a range from 20° C. to 30° C. for a stirring time within a range from 10 minutes to 30 minutes to obtain a dopamine solution;
mixing and stirring 0.1 parts by weight to 20 parts by weight of an initiator and 0.01 parts by weight to 5 parts by weight of a first reactive diluent at a stirring speed within a range from 50 revolutions per minute (rpm) to 800 revolutions per minute (rpm) at a temperature within a range from 10° C. to 30° C. for a stirring time within a range from 20 minutes to 60 minutes to obtain an initiator solution;
mixing and stirring said dopamine solution, said initiator solution, and 20 parts by weight to 80 parts by weight of a second reactive diluent at a stirring speed within a range from 50 revolutions per minute (rpm) to 800 revolutions per minute (rpm) at a temperature within a range from 20° C. to 30° C. for a stirring time within a range from 20 minutes to 60 minutes to obtain a reaction solution;
mixing and stirring said reaction solution and 20 parts by weight to 100 parts by weight of a prepolymer at a stirring speed within a range from 100 revolutions per minute (rpm) to 500 revolutions per minute (rpm) at a temperature within a range from 20° C. to 30° C. for a stirring time within a range from 60 minutes to 120 minutes to obtain a preliminary adhesive; and
stirring and defoaming said preliminary adhesive at a stirring speed within a range from 5 revolutions per minute (rpm) to 50 revolutions per minute (rpm) at a vacuum degree of 0.1 Mpa for 3 hours (Hr) to 8 hours (Hr) to obtain said adhesive.

10. The method according to claim 9, wherein said initiator is a photoinitiator, a thermal initiator, or a combination of the foregoing.

11. The method according to claim 9, wherein said prepolymer is a pure acrylate resin, a bisphenol A epoxy acrylate resin, a novolac epoxy acrylate resin, an epoxidized oil acrylate resin, a modified epoxy acrylate resin, an aliphatic urethane acrylate resin, an aromatic polyurethane acrylate resin, a polyester acrylate resin, a hyperbranched polyfunctional polyester resin, a bisphenol A epoxy resin, a cycloaliphatic epoxy resin, or a combination of the foregoing.

12. A method for preparing an adhesive, comprising:
mixing and stirring 0.01 parts by weight to 30 parts by weight of a dopamine derivative, 0.1 parts by weight to 20 parts by weight of an initiator, and 1 part by weight to 3 parts by weight of phenyl glycidyl ether at a stirring speed within a range from 50 revolutions per minute (rpm) to 800 revolutions per minute (rpm) at a temperature within a range from 10° C. to 30° C. for a stirring time within a range from 20 minutes to 60 minutes to obtain a reaction solution;
mixing and stirring said reaction solution and 0.01 parts by weight to 5 parts by weight of a reactive diluent at a stirring speed within a range from 50 revolutions per minute (rpm) to 800 revolutions per minute (rpm) at a temperature within a range from 10° C. to 30° C. for a stirring time within a range from 20 minutes to 60 minutes to obtain a mixture solution;
mixing and stirring said mixture solution and 20 parts by weight to 100 parts by weight of a prepolymer at a stirring speed within a range from 100 revolutions per minute (rpm) to 500 revolutions per minute (rpm) at a temperature within a range from 20° C. to 30° C. for a stirring time within a range from 60 minutes to 120 minutes to obtain a preliminary adhesive; and
stirring and defoaming said preliminary adhesive at a stirring speed within a range from 5 revolutions per minute (rpm) to 50 revolutions per minute (rpm) at a vacuum degree of 0.1 Mpa for 3 hours (Hr) to 8 hours (Hr) to obtain said adhesive.

13. The method according to claim 12, wherein said initiator is a photoinitiator, a thermal initiator, or a combination of the foregoing.

14. The method according to claim 12, wherein said prepolymer is a pure acrylate resin, a bisphenol A epoxy acrylate resin, a novolac epoxy acrylate resin, an epoxidized oil acrylate resin, a modified epoxy acrylate resin, an aliphatic urethane acrylate resin, an aromatic polyurethane acrylate resin, a polyester acrylate resin, a hyperbranched polyfunctional polyester resin, a bisphenol A epoxy resin, a cycloaliphatic epoxy resin, or a combination of the foregoing.

15. An adhesive according to Formula (1): 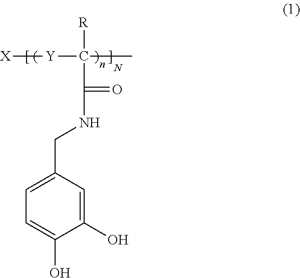
wherein, X represents a crosslinked or partially crosslinked prepolymer; R represents hydrogen, hydroxyl, alkyl, or alkoxy; Y represents alkyl, cycloalkyl, aryl, or aralkyl; and each of n and N is an integer larger than 1.
